(19) United States
(12) Patent Application Publication
(10) Pub. No.: US 2015/0303689 A1
(43) Pub. Date: Oct. 22, 2015

(54) SYSTEMS AND METHODS FOR POWER CONTROL AND ENERGY MANAGEMENT

(71) Applicant: LOGIOS, LLC, Boston, MA (US)

(72) Inventors: Gustavo Collantes, Davis, CA (US); Michael Pesin, Newcastle, WA (US)

(73) Assignee: LOGIOS, LLC, Boston, MA (US)

(21) Appl. No.: 14/650,839

(22) PCT Filed: Aug. 16, 2013
(86) PCT No.: PCT/US13/55377

§ 371 Date: Jun. 9, 2015

Related U.S. Application Data
(60) Provisional application No. 61/684,406, filed on Aug. 17, 2012.

(51) Int. Cl. H02J 3/00; G05B 15/02

(52) U.S. Cl. CPC H02J 3/00; G05B 15/02

(57) ABSTRACT

A method of power control and energy management is provided. The method includes the steps of obtaining data from variable power generation facilitie(s) and obtaining data from customer load(s) at sampling frequencies of at least one sample per minute; defining a reference generation; calculating a charge assignment based on said data from one or more variable power generation facilities, said data from one or more customer loads, and said reference generation; determining a charging signal based on said charge assignment; and sending said charging signal to a customer load and/or a storage system at a rate of more than one per minute. Computer assisted methods and computer readable devices are also provided herewith. Thus, this invention provides an improved efficiency of integrating and managing power from variable sources of energy, such as wind energy.

### PRIORITY

This application claims priority to U.S. Provisional Application Ser. No. 61/684,406 filed Aug. 17, 2012.

### FIELD OF THE INVENTION

The present invention relates generally to the field of power control and energy management.

### BACKGROUND

The production of energy from wind, solar and other renewable sources can play a significant role in diversifying the power generation mix and in reducing the environmental impacts of energy consumption. The levelized cost of generating electricity from wind has become increasingly competitive which, together with government regulations, has resulted in a sustained growth in solar and wind-energy installed capacity.

The efficient integration of wind energy into the power system has been challenging though. Challenges arise from the intermittency that characterizes wind power production and the virtual impossibility to predict this intermittency with certainty. The combination of these factors makes it necessary for system operators to adopt any number of strategies to effectively integrate wind generation into the power system.

One strategy to mitigate these challenges has been the development of better methodologies to forecast wind power generation. Progress has been made in this area with development of methods that use statistics, neural networks, Monte Carlo simulation, and other techniques. However, differences between wind generation forecasts and actual wind generation remain tangible and sometimes they are significant. A second strategy has been the use of large-scale energy storage. Energy from wind power plants could be stored in batteries, flywheels, ultracapacitors or other devices. It could also be used to pump water back into hydropower reservoirs. These and other strategies to store wind energy involve generally significant economic inefficiencies through capital and operating expenditures, as well as through energy losses.

In real operations, system operators manage the variability in wind and solar generation with the use of ancillary services. This is implemented through complicated processes that typically involve bids by and selections of ancillary services providers. Generation units are then called in to increase or decrease their output. Sometimes, when generation from a wind farm is very high, the system operator may request this wind farm to reduce output, resulting in environmental losses and economic losses for the wind farm owner.

Additionally, consumers currently do not have means to directly control their use of clean energy unless they install clean energy generators, such as solar panels, at their location. Consumers can choose to participate of electric utility programs to support the incremental use of renewable energy across their system, but this incremental green energy is distributed across all customers.

Thus, there is a need for improvements in the cost-effectiveness of integrating and managing energy from variable sources of energy, such as wind and solar, and to enable consumers to have more control over their level of use of clean energy.

### SUMMARY

In accordance with certain embodiments, the present invention relate to methods including computer-assisted methods and computer readable devices having instructions stored thereon for causing a computer to implement a method. In some embodiments, such method is a method of power control and energy management comprising: obtaining real time data from one or more variable power generation facilities at a sampling frequency of at least one sample per minute; obtaining real time data from one or more customer loads at a sampling frequency of at least one sample per minute; optionally exchanging information with the system operator; defining a reference generation; calculating a charge assignment based on said data from one or more variable power generation facilities, said data from one or more customer loads, said information from the system operator, and said reference generation; determining charge signals based on said charge assignment; and sending said charge signals to customer loads and/or to a storage system at a rate of more than one per minute. In some embodiments, the method provides a balancing functionality whereby instantaneous generation surplus is completely allocated to customer loads. In some embodiments, the method provides a user-control functionality that allows the user to control charge and/or monitor the energy received. Two or more distinct customer types are distinguished and charge assignments can be calculated.

In some embodiments, the sampling frequency and/or sampling rates are more than ten samples per minute or more than one sample per second. In some embodiments, each of the sampling frequencies and sampling rates are more than ten samples per minute or more than one sample per second. The methods as provided herein may also provide ancillary service(s) such as load balancing.

In some embodiments, a variable power generation facility is a wind energy farm. In some embodiments, there are multiple wind farms. The data from the wind energy farm or other variable power generation facilities may include both total power and change in power.

In some embodiments, a variable power generation facility is a solar energy farm. In some embodiments, there are multiple solar farms. The data from the solar energy farm or other variable power generation facilities may include both total power and change in power.

In some embodiments, there are multiple variable power generation facilities that comprise two or more wind energy farms, two or more solar energy farms, or both wind energy farm(s) and solar energy farm(s)

In some embodiments, the step of dynamically calculating charge assignment comprises using a charge assignment algorithm to assign specific amounts of charge to each online customer load. In some embodiments, the Independent System Operator (ISO) does not participate in the method of power control and energy management. In other embodiments, the ISO provides congestion information.

These and other features of the embodiments as will be apparent are set forth and described herein.

### BRIEF DESCRIPTION OF THE DRAWINGS

A detailed description of various embodiments is provided herein below with reference, by way of example, to the following drawings. The skilled person in the art will understand that the drawings, described below, are for illustration purposes only. The drawings are not intended to limit the scope of the applicant's teachings in any way.

FIG. 1 is an example of wind generation during a 3,600-second period and reference generation for the same period.

FIG. 2 is an example of wind generation surplus during a 20-second period, with constant reference generation.

FIG. 3 is an example of wind generation surplus during a 20-second period, with stepwise varying reference generation.

FIG. 4 is an example of wind generation surplus during a 20-second period, with linearly varying reference generation.

FIG. 5 is an example of wind generation surplus during a 20-second period, with two segments of linearly varying reference generation.

FIG. 6 is an example of wind generation surplus during a 20-second period, with arbitrary reference generation.

FIG. 7 is an example of wind generation surplus during a 20-second period, with exaggerated arbitrary reference generation.

FIG. 8 is an example of wind generation surplus during a 20-second period, with exaggerated arbitrary reference generation.

FIG. 9 is an example of wind generation and an average reference generation for a 3600-second period.

FIG. 10 is an example of wind generation surplus during a 20-second period, as in FIG. 7, with minimum-level reference generation.

FIG. 11 is a diagram showing a full-storage system configuration.

FIG. 12 is a diagram showing a peak-storage system configuration.

FIG. 13 is a diagram showing a no-storage system configuration.

FIG. 14 is a diagram showing a flow of information within the system.

FIG. 15 is a diagram showing data acquisition at the turbine level.

FIG. 16 is a diagram showing data acquisition at the feeder level.

FIG. 17 is a diagram showing data acquisition at the substation level.

FIG. 18 is a diagram showing data acquisition at the transmission level.

FIG. 19 is a flow chart exemplifying one embodiment of the invention.

FIG. 20 is a diagram showing a computer system that can be used to implement the computer-assisted methods and includes one or more software modules.

It will be understood that the drawings are exemplary only and that all reference to the drawings is made for the purpose of illustration only, and is not intended to limit the scope of the embodiments described herein below in any way. For convenience, reference numerals may also be repeated (with or without an offset) throughout the figures to indicate analogous components or features.

### DETAILED DESCRIPTION

### Definitions

Charge Assignment: This phrase, as used herein, refers to the decision about the level of instantaneous power that customer loads will receive at a given point in time.

Charge signal: This phrase, as used herein, refers to the information about the instantaneous power to be supplied to and/or received by a load, in a format that can be transmitted through a communication system and/or electric circuit. The information contained in the charge signal is determined by converting the charge assignment to the particular load into an appropriate form, such as digital.

Charge: This term, as used herein, is defined as an amount (block) of electric energy sent to (consumed by or stored by) a device/appliance or a group of devices/appliances.

Congestion information: This phrase, as used herein, refers to information about whether the transmission and/or distribution system can support the additional power generated by a generation facility.

Continuous signal: This phrase, as used herein, refers to a signal that is sent and received at an arbitrarily high frequency, typically in the order of one second or less.

Customer: This term, as used herein, refers to a person or entity that is registered to use the system and methods as described herein.

Customer load: This term, as used herein, refers to an electrical load (appliance) that is owned or operated by a customer, registered and capable to be served by the system and methods as described herein. A customer load may be a flexible load, though not necessarily. Unless otherwise specified, references to customer loads may also include storage loads.

Dispatchable customer load: This term is herein used interchangeably with online customer load (see definition below).

Flexible load: Load that can properly function while receiving variable amounts of instantaneous power.

Generation balancing: This phrase, as used herein, refers to the process by which all generation surpluses are allocated to customer loads and/or storage devices.

Generation deficit: This phrase, as used herein, refers to the deficit in power generated at the generation facility relative to the reference generation at a given point in time. Whenever the generation power is equal to or greater than the reference generation, the generation deficit is equal to zero.

Generation excess: This phrase is used herein interchangeably with generation surplus (see definition below).

Generation facility: This phrase, as used herein, refers to any level of aggregation of individual generation units within a power plant. For example, a generation facility may include a single wind turbine, a set of wind turbines connected to the same feeder, or the set of all wind turbines within the wind farm.

Generation surplus: This phrase, as used herein, refers to the excess in instantaneous power generated by a generation facility relative to the reference generation. Whenever the power generation is equal to or lower than the reference generation, the generation surplus is equal to zero.

Independent System Operator or ISO: This phrase, as used herein, refers to organizations that oversee and control the operation of electrical power systems, including market operations, within a specific region. Depending on the region and size of the region in question, these organizations can take different names, such as Regional Transmission Organization (RTO), Independent Electricity System Operator (IESO) in Canada. Information is exchanged with the system operator as needed.

Listed customer: This phrase, as used herein, refers to customer to whom the power control and energy management (PCEM) method as described herein strives to deliver a specified amount of energy by a specified time.

Load balancing: This phrase, as used herein, refers to coordination between power generation and power demand such that both are approximately equal to each other at every time. In some embodiments, a load is balanced when it requires no correction on the part of, for example, the ISO. Thus, the present invention can provide for both injecting and simultaneously extract power, in a way that the system virtually does not notice it.

Online customer load: This phrase, as used herein, refers to customer loads that are connected at a given point in time and are ready to be assigned charge from the PCEM method as described herein.

Operating hour: This phrase, as used herein, refers to the time interval for which the ISO schedules generating units so that they can meet expected demand. Typically, the operating hours correspond with the clock hours.

Real time data: For the purposes of the present specification, this term refers to signals that transmit and/or receive information with a time lag between data generation and data transmission of no more than required for the PCEM method described herein. Typically, it would be less than 10 seconds and in some preferred embodiments the time lag can be less than 1 second, or less than 0.1 second, or less than 0.01 second. For all practical purposes, real-time signals as described herein transmit information about the instantaneous attributes of a particular phenomenon, such as power from a wind farm generation. This is to be differentiated from the qualifier “real-time” as used to describe some electricity markets. In such case, real-time refers to markets operating in time windows of typically 5 to 10 minutes.

Reference generation: This phrase, as used herein, refers to a level of power generation from a generation facility at a given point in time that is used to determine in real time the amount of power from the same facility that can be distributed among customer loads (sec definition of generation surplus). The PCEM method considers all generation over the reference generation as available for distribution to customer loads. The reference generation is determined endogenously. A typical example of reference generation can be the mean generation forecast for a particular operating hour, which is typically a constant value over the hour, with transition interpolations between values in contiguous hours. In some embodiments, the reference generation does not need to be constant or to vary according to any specific functional font. The reference generation is better thought of as a sequence of points that take a specific form at the beginning of the operating hour (e.g. the mean generation forecast) but the present methods can dynamically modified it on demand during the hour.

Spinning reserve: This phrase describes the power generation capacity that is online and synchronized with the grid and that can be dispatched quickly to meet differences between actual and expected generation.

Standby customer: This phrase, as used herein, refers to a customer who stands ready to receive charge at any time while being connected. Standby customers are not guaranteed to receive any specific amount of energy during a given period of time and they receive charge as the PCEM method's charge assignment algorithms assign it to them.

Storage load: This term, as used herein, refers to a device that is capable of storing energy from generation facilities for the purpose of being delivered again at a later point in time. Examples of such devices include electrochemical batteries, flywheels, and ultracapacitors. Storage loads may or may not be owned or operated by a customer.

Total online customer load: This phrase, as used herein, refers to the sum of the rated input power for all the customer loads that are connected at a given point in time.

Variable generation: This phrase, as used herein, refers to power generation that is not continuously available at a predetermined value due to factors outside of the control of the operator. Variable generation is often referred to as intermittent generation or non-dispatchable generation.

VGen-RTI: This term, as used herein, refers to an embodiment of the system and PCEM methods as described and claimed herein using real time and continuous signaling

### The Elements

The methods and systems as provided herein use technology such as Variable Generation Integration (VGen-I) technology which provides a method of power control and energy management having the steps of:
obtaining data from one or more variable power generation facilities at a sampling frequency of at least one sample per minute;
obtaining data from one or more customer loads at a sampling frequency of at least one sample per minute;
defining a reference generation for every sample;
calculating a charge assignment based on said data from one or more variable power generation facilities, said data from one or more customer loads, and said reference generation;
determining a charging signal based on said charge assignment; and
sending said charging signal to a customer load and/or a storage load at a rate of more than one per minute.

In some embodiments, the methods and systems here, are provided in real time, Variable Generation Real-Time Integration (VGen-RTI) technology and comprises the following elements:

Real-time continuous generation signal

Real-time continuous customer load signal;

Dynamic determination of reference generation;

Power control and energy management algorithm;

Continuous remote charging signal (pulse or regulated);

Generation balancing functionality;

Clean energy use accounting;

Real-time information to users;

User control functionality; and

Market differentiation functionality.

In further detail the power control and energy management methods as described herein, which include, for example, VGen-RTI technology as comprises the following elements. The use of signals that are both real-time and continuous (RTC) can be particularly useful in some embodiments of the present invention. Using signals that are only real-time or only continuous would not enable as accurate correspondence between power generation and load. Thus, to optimize functionalities, both real-time and continuous data sampling is preferred. However, in some embodiments, the use of signals that are slower than real time (e.g, one to 10-second transmission delay) or sampled less frequently (e.g., six samples per minute) may be used to provide an acceptable implementation of the functionality of the methods as described herein.

Power Generation Signal

Data is remotely collected from generation facilities, using appropriate protocols such as IEC 61850-8 and IEC 61400-25. In some embodiments, the data is collected in real-time. In some embodiments, the data is collected with delays larger than real-time but still sufficient to optimize the V-Gen-RTI functionality.

Protocols such as IEC 61850 specify data transmissions with delays not to exceed 4 milliseconds. Thus, when these protocols are used, the transmission delay is 4 ms or less. The data collected typically include current and voltage, from which the generation power can be directly calculated (power equals current times voltage). Depending on the hardware used, it may be possible to collect data on power directly. In some embodiments, data can be collected at different levels, including the generator level, the feeder level, the substation level, the transmission level, and combinations thereof.

Generation data may be sampled at high (≧1 sample/minute) or very high (≧6 sample/minute) frequencies. For sampling at very high frequencies, the sampling may be considered to be a continuous sampling for most practical purposes, and is considered continuous in the present methods.

In some embodiments, collecting data at lower frequencies may be acceptable if it is possible to obtain accurate estimates of the generation signal between sampling points.

In the United States, power lines operate with frequencies of 60 hertz, which renders the period equal to 16.67 milliseconds. A robust data sampling frequency is one that enables a consistent measurement and/or estimation of continuous or Root Mean Square power. In some embodiments, the RTC power generation signal is sampled at intervals of less than 1 minute, less than 30 sec., less than 20 sec., less than 15 sec., less than 10 sec., less than 8 sec., less than 7 sec., less than 6 sec., less than 5 sec., less than 4 sec., less than 3 sec., less than 2 sec., or less than 1 sec.

RTC Load Signal

A second RTC signal used relates to loads. In some embodiments, the data may be collected in real-time. In some embodiments, the data is collected with delays larger than real-time but still sufficient to optimize functionality.

Load-related data may be sampled at high (≧1 sample/minute) or very high (≧6 sample/minute) frequencies. For sampling at very high frequencies, the sampling may be considered to be a continuous sampling for all practical purposes, and is considered continuous in the present methods.

In some embodiments, collecting data at lower frequencies may be acceptable if it is possible to obtain accurate estimates of the load signal between sampling points.

Data on each of the customer loads (e.g. appliances) is collected remotely to determine when they are online, the rate at which they can receive charge, and the amount of energy that they could receive, among other possible variables.

The aggregation of the individual signals gives information on the total online customer load (aggregate input power), representing the maximum amount of power that can be assigned to customers, and the total energy that should be received by the customer loads.

Exemplary customer loads are mobile devices such as cell phones and laptops, utility, commercial, industrial, and residential-scale energy storage devices such as electrochemical batteries, flywheels, and ultracapacitors, plug-in electric vehicles, electrical compressors, electrolyzers, water heaters, heating, ventilation and air conditioning (HVAC), drying machines, refrigeration systems, ice energy storage, industrial electrical machinery capable of operating within ranges of input power such as electric smelters and electric pumps, and many others.

Dynamic Calculation of Reference Generation Points

System operators and power plant operators agree on the amount of power that the power plant will deliver to the system over a given operation hour. This agreement is informed by the forecast of generation from the power plant for that hour, which is typically provided by a forecasting agent. The agreement generally takes place no later than one hour before the beginning of the operation hour. The forecast is, of necessity, generated even earlier than the moment of the agreement.

The reference generation is a generation level that can be constant over an operation hour or not. The reference generation is determined internally and this determination is informed by parameters such as the estimated customer loads and the forecasted power generation from the generation facility during the operating hour.

The reference generation is determined in a way such that ensures that all the generation over this reference (surplus generation) can be allocated among online customer loads.

One simple example of reference generation would be a generation forecast for the particular operating hour. In this case, generation surplus is the generation at each sample point in excess of the forecasted value for the particular operating hour.

Unlike forecasts, which need to be defined well in advance (typically one hour) of the beginning of the operating hour, the reference generation can be defined, in agreement with the power plant operator, much closer to the beginning of the operating hour. The reference generation can even be revised during the operating hour, provided that all the affected parties are in agreement and that the total online customer load is sufficient to balance the generation surplus. In this sense, the reference generation is a dynamic parameter whose values can be defined in real time. Therefore, it is appropriate to think of this reference not strictly as a line but as a sequence of points defined at a frequency consistent with that of the sample points in the generation signal.

From a practical standpoint, before the operation hour begins, it may be more useful to the system operator to think of the reference generation as a constant value for the duration of the operation hour. This gives the system operator more predictability to plan their unit commitments. During the operation hour, the system operator may prefer to think of the reference generation as a sequence of points that can be dynamically specified to create higher or lower levels of generation surplus, thus enabling the provision of services such as real-time frequency regulation and balancing.

Charge Assignment Algorithm

The charge assignment algorithm (CAA) is used to calculate a charge assignment and thus provide a balancing functionality. CAA receives two real-time signals, generation and load. With these signals and the reference generation point for the particular point in time, CAA calculates the generation surplus that can be distributed among online customer loads.

CAA then assigns specific amounts of charge to each online customer load according to its queuing-scheduling (QS) module. The QS module operates under a pre-specified set of rules. The set of rules recognizes technical, economic, as well as behavioral factors in order to globally optimize charge assignments.

The set of rules in our QS module includes the condition that the instantaneous generation surplus is allocated completely. This generation surplus clearing condition is the source of the generation balancing functionality of our technology.

CAA can account for any constraints in the transmission and distribution systems.

CAA is also able to recognize market differentiation specified for the area being served. In particular, CAA uses a proprietary algorithm to effectively serve listed customers.

RTC Charge Signal

A third RTC signal that may be used relates to charging online loads. The present method can take the output of the charge assignment algorithm and continuously sends real-time signals to the controls of each online customer load. These signals direct the controls to deliver charge to the load at a specific, not necessarily constant rate. The instantaneous charge rate for each load can take any value from zero to the maximum input power of the particular load, contingent on meeting operating requirements for the particular load.

Generation Balancing Functionality

The power control and energy management methods as described herein have the capability to allocate the entire generation surplus at every (sampled) point in time among online loads, thus delivering a generation balancing functionality.

Clean Energy Use Accounting

Because power generation signals and charge signals are coordinated in real time, customer loads store the surplus energy delivered by the generation facility to the system in real time, and thus a direct, almost exact correlation between customer load energy use and green energy production is demonstrated.

In some embodiments, the PCEM methods as described herein maintain records of the energy delivered to every customer load. Because the invention described herein is specifically well suited for variable generation units, which are generally renewable energy units, accounting of the renewable energy assigned to customer loads can be delivered.

Customer Control Functionality

The PCEM methods as described herein can enable customers to: (a) Control their charging, (b) Monitor their use of clean energy, and (c) Network with other users or groups of users.

In some embodiments, customers can opt to receive charge within a time window of their choice (listed customers) or to receive charge intermittently as part of a large pool of customers (standby customers). The first option gives customers certainty about the amount of charge they will receive and by what time they will receive it. The second option gives customers freedom to connect and disconnect their appliances at any time.

Central to the notion of giving control to customers is the ability to provide them with information. For example, in some embodiments, both listed and standby customers can continuously access information about their use of the method including the amount of green energy they received. In some embodiments, standby customers can, at the moment of connecting, see an estimate of the rate of charging they can expect, based on parameters such as the expected available power and the characteristics of the online customer pool at that time.

The present invention can also deliver information to customers as a strategy toward the objective of efficiently balance generation surplus with customer loads. For example, as the forecasting system expects a jump in generation surplus, Customers are informed about this opportunity to receive more and/or more continuous power. This helps the presently described methods “herd” customers into a narrow time window, thus having a larger pool of customer loads to which it can assign power.

In some embodiments, customers can network with other users and interact in a variety of ways, from competing to trading green energy use, to negotiating orders of priority in the queue.

Market Differentiation Functionality

The PCEM methods as described herein can accommodate market segments with different characteristics or requirements. Market differentiations are tailored to the specific service area and embedded in our charge assignment algorithms. The market differentiation functionality provides for the differentiation of listed customers vs. standby customers. Thus, these two groups can be distinguished and treated differently.

### Technology Description

The present methods and systems provide a technology that enables the effective, efficient and complete integration of variable power generation.

The present methods and systems provide also a technology that enables consumers to synchronize their consumption of energy with the generation of green energy.

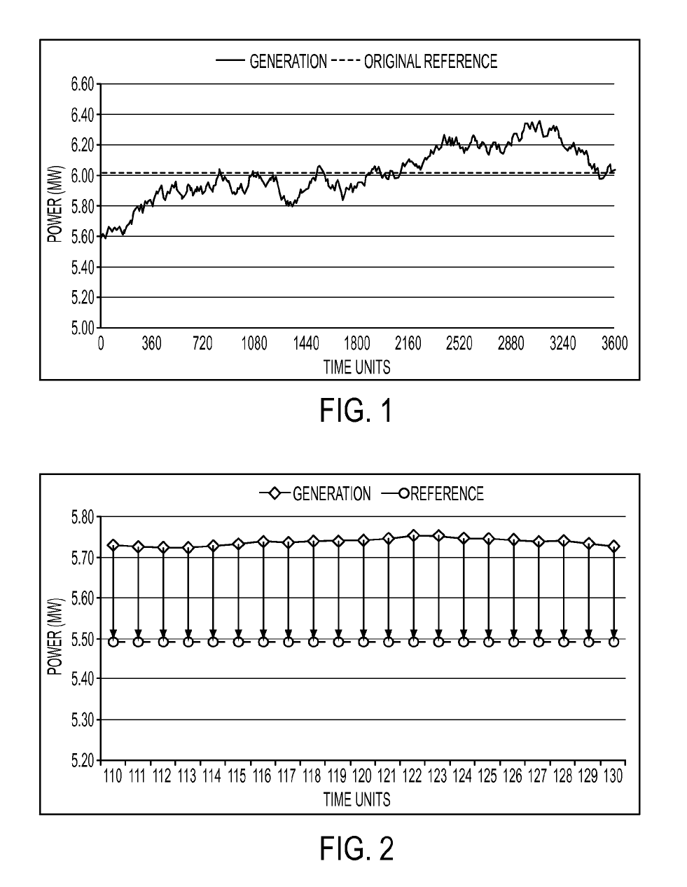

FIG. 1 shows simulated data of power generation from a wind farm second-by-second during a one-hour period. Data at such high frequencies is currently not reported, much less real-time. For the operation of power systems, wind power is typically presented as forecasts for each operation hour. Such forecasts are reported as estimated mean power generation for and one hour ahead of the hour in question. The line labeled “original reference” in FIG. 1 exemplifies the generation for this hour, as would be provided by a forecast.

To illustrate an embodiment of the invention, FIG. 2 provides a zoom in a 20-second window on the left part of FIG. 1, showing for this short segment the power generation and the forecast generation. For the purposes of the discussion, it is assumed that this forecast is the reference generation. As it is discussed below, the functionalities of the present invention can be delivered with different choices of the reference generation.

The present invention uses high-frequency samples of generation power in real time, it applies any necessary or preferential corrections (such as phase corrections), compares the value of the sample with that of the reference for the corresponding point in time, and calculates the generation surplus. This is illustrated in FIG. 2 where each marker on the generation curve represents a sample, each markers on the reference curve represent the corresponding reference value, and the arrows represent the generation surplus.

In the particular example shown in FIG. 2, samples are taken at a frequency of one per second. Each sample provides a measurement of the instantaneous power generation. Depending on the hardware that is used, samples of generation power can be obtained either directly or indirectly as samples of current and voltage (from which power can be calculated). Although current merging units are capable of collecting thousands of samples per second, for the purpose of power system operations and management, sampling frequencies in the order of 1-10 per second are considered very high-frequency sampling. As a matter of illustration, it typically takes five seconds for a wind turbine rotor to complete one revolution.

At every sampling time, the present methods send real-time charging signals to customer loads and/or the storage system so that the aggregate charge equals the instantaneous generation surplus. Thus, generation surplus is balanced with customer loads and storage.

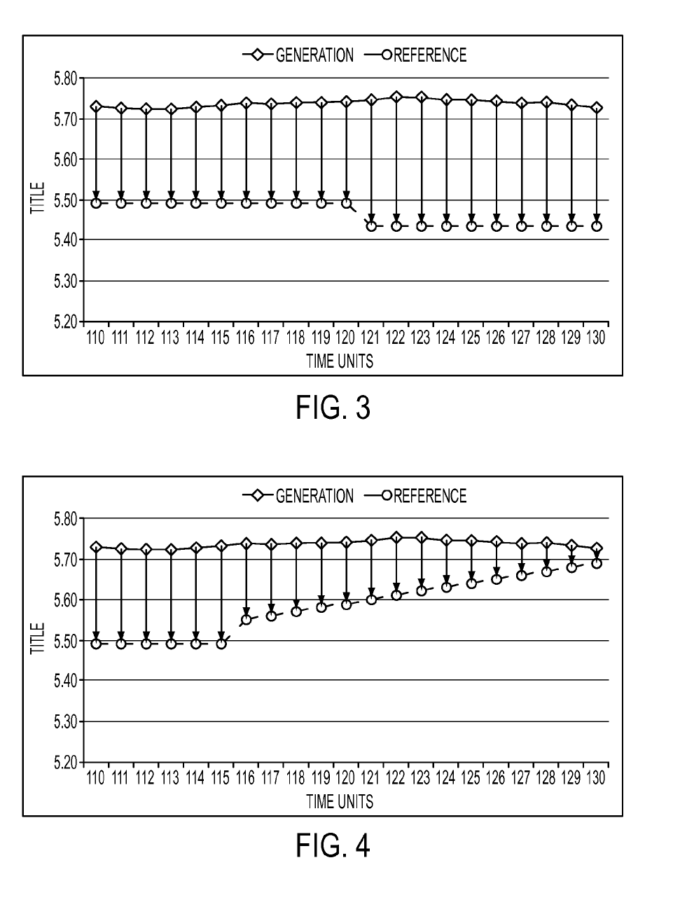

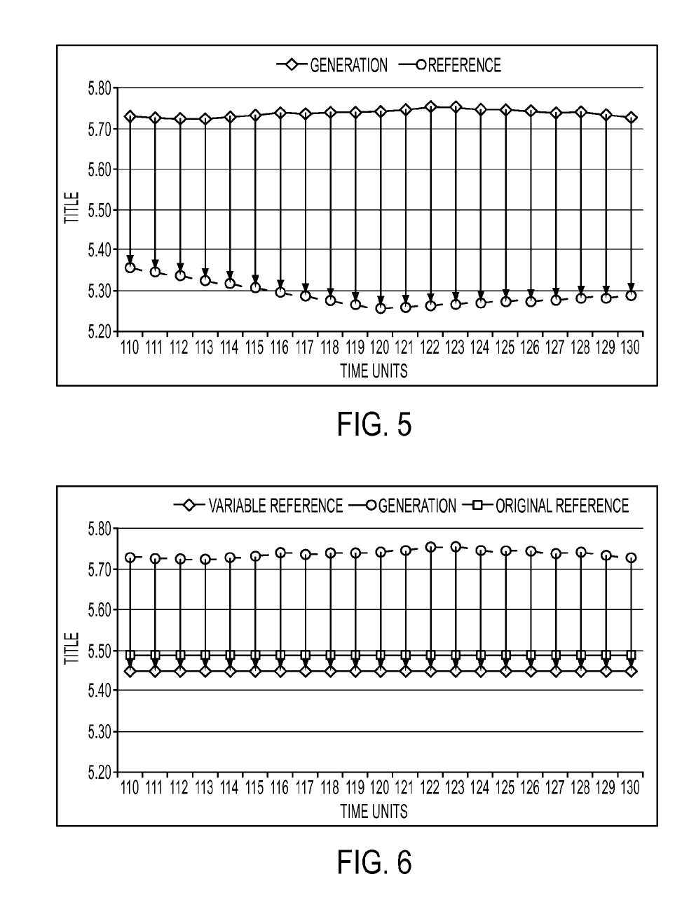

This balancing functionality can be offered with any form of the reference generation. FIGS. 3, 4, 5, and 6 show variants of FIG. 2 where the reference generation takes a step, constant-linear, double linear, and general functional forms, respectively. FIG. 6 shows with a dashed line for reference the original reference generation shown in FIG. 2. The reference generation FIG. 6 takes a general functional form, although it looks like a constant because of the very narrow time window displayed in the figure.

While the ability to work with a constant reference generation is key to provide the power plant operator and the system operator with certainty, the ability to work with arbitrary forms of reference generation is at the heart of the extremely powerful ancillary services functionality. Typically, at the start of an operation hour, power plant and system operators may want to count on the power control and energy management methods and systems as described herein to balance generation surplus relative to a constant reference, thus reducing or eliminating uncertainties and penalties related to variable generation. During the course of the operation hour, the power plant operator or, more likely, the system operator may be interested in asking the system to modify its reference generation. Such a situation may arise, for example, when the power plant needs to shut down or bring back online a generation unit, or when the system operator wants to balance system load with additional or lower power from the variable power plant.

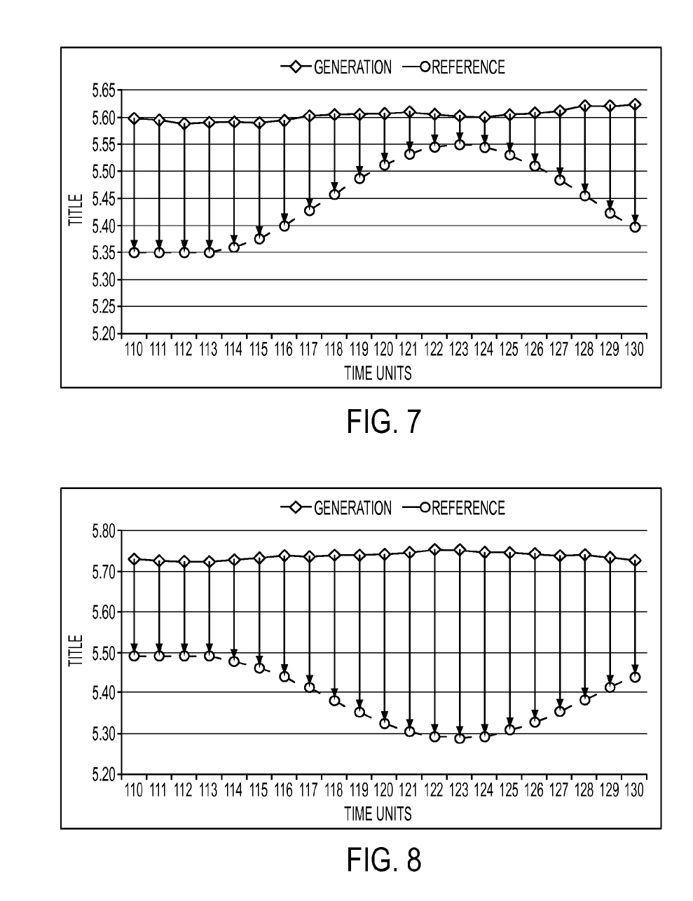

To illustrate scenarios of this type more clearly, FIG. 7 and FIG. 8 show versions of FIG. 6 with exaggerated variations in the reference lines. FIG. 7 shows a reference generation that is initially constant to then start an ascending trend to, for example, help balance an increase in system demand. FIG. 8 shows a situation with decreasing reference to, for example, help balance a decrease in system demand.

The provision of ancillary services such as load balancing through VGen-RTI can be implemented in a variety of ways. It can be controlled directly by VGen-RTI, it can be provided by VGen-RTI with participation of customers (eliciting their decision to reduce or postpone charging based on a set of decision variables, such as economic), or other arrangements.

Under ancillary service implementation scenarios, the system operator would typically need to provide information about the type and level of service needed. The ability of VGen-RTI to effectively provide such services would depend on the available cumulative online load (including storage) and, more specifically, the amount of Toad that is available to participate in the provision of services (for example, many customers may be interested in receiving more charge but not interested in reducing or postponing their charge). VGen-RTI is thus capable of providing ancillary services in real-time.

The ability to provide ancillary services in real time is a significant breakthrough in the way that such services are provided. Currently, ancillary services are arranged and delivered predominantly through bidding systems before the start of the operation hour. The commitment of generation or storage units to provide such services and the bidding process itself are sources of inefficiency that could be reduced or eliminated with the use of VGen-RTI ancillary services.

The examples described thus far involve generation surplus, i.e. situations when the power generation from the wind farm exceeds the generation forecast for a particular point in time. VGen-RTI does not offer a functionality that directly and completely compensates for generation deficits relative to the forecast. However, to understand the full dimension of VGen-RTI's functionality, it is important to understand that there is no inherent restriction, from a functional point of view, on the value adopted for reference generation. As a consequence, the extent to which situations with generation deficit present themselves is directly dependent on form adopted for the reference generation.

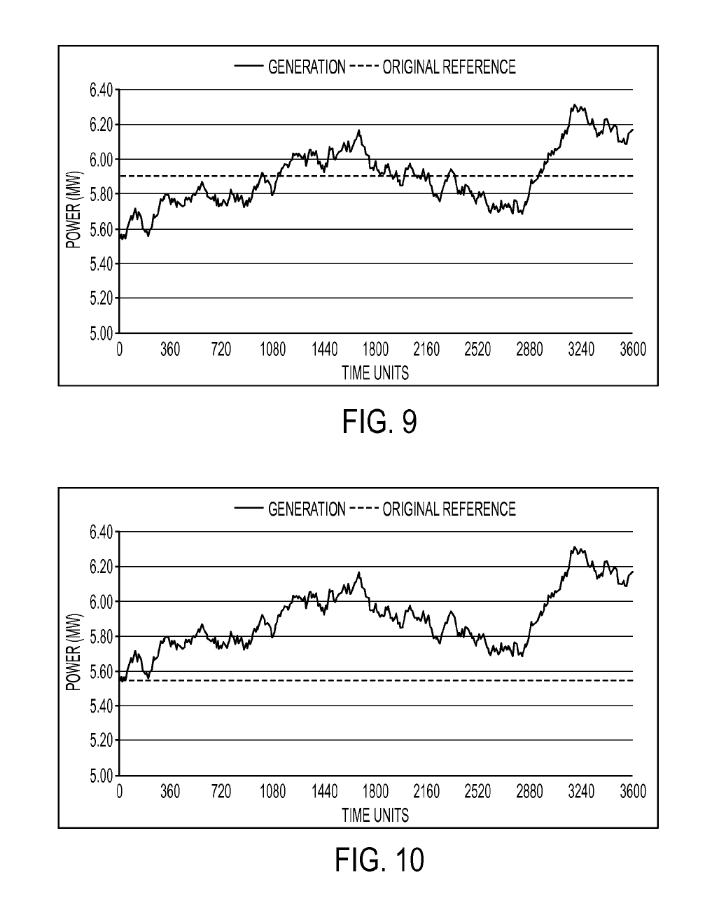

To illustrate this point, FIG. 9 shows an example of wind generation data for a one-hour period and a reference generation representing the generation forecast for that period. In this case, segments of both generation surplus and deficit are found. FIG. 10, on the other hand, shows the same generation data but with the reference generation chosen at a lower level. For the purpose of illustration, the reference generation is chosen to coincide with the minimum instantaneous power produced by the wind farm during the period in question. In this ease, there is no generation deficit and generation surplus is found throughout the period.

The main intent of this discussion is to highlight that the concepts of generation surplus and generation deficit are artifacts of the form adopted for the reference generation, for which in turn there is no inherent restriction except the particular preferences of the involved parties. Wind generation is exogenous (i.e. parties have no control over it) while reference generation is endogenous (i.e. it is defined based on the preferences of the parties).

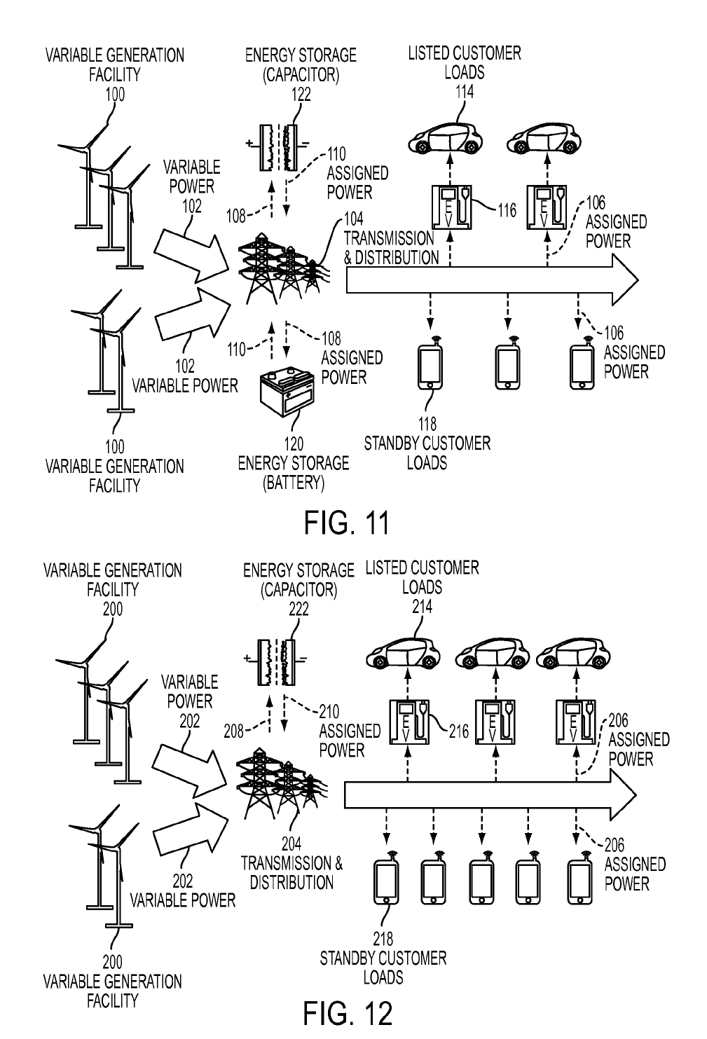

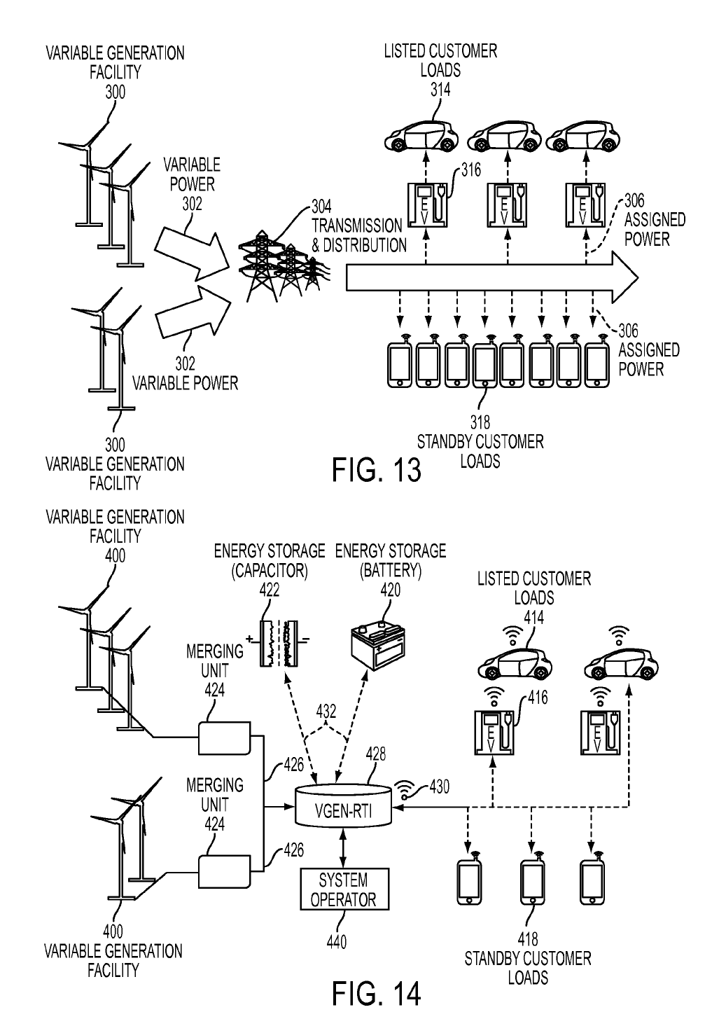

As described in FIGS. 11-13, power “flows” from the generating facilities to the customer loads. FIGS. 11-13 describe graphically the flow of power under three possible system configurations using the methods of the present invention. These configurations are distinguished as full-storage (FIG. 11), peak-storage (FIG. 12), and no-storage (FIG. 13) configurations, respectively. In one preferred embodiment, the methods as described herein will operate under no-storage configurations in most or all cases, because it constitutes the most energy- environmentally- and economically-efficient case. However, full- and peak-storage configurations may be needed in some cases, particularly without significant market penetration and thus a lower total customer load.

As shown in the figures, participation is open to any number of generation facilities within the same interconnection, irrespective of their generation capacity.

As shown in the embodiment described by FIG. 11, the generating facilities (100) deliver power (102) to the transmission system (104) normally. For every point in time, the system operator (not shown) dispatches all power up to the reference generation in the usual manner. VGen-RTI's assigns generation surplus entirely, by means of its charge assignment algorithms, either to customer loads (114 and 118) or to the storage systems (120 and 122). Charge assigned to customer loads (106) and storage systems (108) is shown as dashed arrows, indicating that charge is not necessarily continuous or constant. The generation surplus is assigned to the customer loads including the listed customer loads (114) which is exemplified in FIG. 11 as being an electrical vehicle, which is charged by a charging station (116) and standby customer loads (118) which is exemplified as cell phones.

The use of the methods as described herein does not add any extra work to the generation facility operators. In fact, VGen-RTI can simplify their operations. For example, operators do not need to worry about receiving requests from the system operator to reduce their output.

The figures show charge to (108)/from (110) storage flowing from/to the transmission and/or distribution lines (104), indicating that storage (120, 122) is not necessarily co-located, though it could be co-located with other components of the system, such as generation facilities (100), charge control devices (116), or customer loads (114, 118).

Typically, charge is assigned to energy storage (108) when that charge cannot, for any reason, be assigned to customer loads. In particular, storage becomes necessary whenever the expected amount of power or energy that VGen-RTI needs to assign is larger than the cumulative input power or energy storage available from customer loads.

FIG. 12 illustrates a case with larger customer adoption, where customer loads can accommodate more energy over a period of time, thereby obviating the need for lower-power, higher-density energy storage, such as batteries. This case can be served with a peak-storage system configuration, whereby the energy storage units, such as ultra capacitors (122), are included only to absorb short-duration jumps in power and to release that power back to online customer loads over a longer period of time. The peak-storage system configuration is preferable to the full-storage system configuration, since it avoids the capital, efficiency, and operating costs related to purchasing, installing, maintaining and managing battery units.

FIG. 13 illustrates a case with even larger customer adoption, where customer loads can accommodate all power and energy during any period of time, thereby obviating the need for any type of energy storage. This case can be served with a no-storage system configuration, whereby the energy storage units are excluded altogether and all power and energy is directly assigned to online customer loads. The no-storage system configuration is the most preferable configuration, since it avoids the capital, efficiency, and operating costs related to purchasing, installing, maintaining and managing storage units.

A system configuration including lower-power, higher-density energy storage units (e.g. batteries) and no higher-power, lower-density energy storage units (e.g. ultra capacitors, flywheels) is also possible and may prove preferable in certain situations. Such lower-power storage system configuration is not illustrated here to reduce space. Notice also that the descriptions of the system configurations do not make mention of the size of the energy storage units. Thus, for example, a full-storage system configuration could look more similar to a no-storage system configuration as the size of the energy storage units are reduced.

The use of the methods as described herein should result in the reduction of costs of operating variable generation facilities. For example, plant operators could reduce the amount of spinning reserve they need to maintain.

The way that power “flows” in the system is determined by the flows of information, which is described in FIG. 14. A device such as a merging unit (424) collects information on voltage and current from the generation facility with high frequency (for example, one sample every second). The merging unit sends a signal (426) with this information in real time (recall reference to IEC protocols) to the VGen-RTI processor (428). VGen-RTI also receives signals from customer loads (430) and storage systems (432).

VGen-RTI then sends charging signals to online customers (also represented in the bidirectional arrows 430) and to storage systems (also represented in the bidirectional arrows 432).

VGen-RTI can communicate with the system operator (440). Communication with the system operator may be important for a variety of reasons, for example, to receive information about constraints in the transmission or distribution systems, to provide ancillary services, etc.

VGen-RTI can negotiate charging services over given periods of time with prospective listed customers (414). VGen-RTI is able to commit to deliver an agreed-upon amount of energy during an agreed-upon time window.

In order to preserve the real-time functionality, the charge assignment algorithm is preferably extremely fast. The use of real-time continuous signals, at the same time, enables strategies to reduce computing time. For example, in some embodiments, because of the high sampling frequency that VGen-RTI uses, power generation will only vary marginally from one sample point to the next. Thus, computing can focus on the margins and not necessarily evaluate the entire system.

In some embodiments, real-time values of power output from a generation facility could be collected with existing generation data acquisition systems. Alternatively, with EIC61850 system architecture, a merging unit would collect signals on current and voltage. The metered data is sent according to standard protocols, such as IEC 61850, to an Ethernet switch/hub, which in turn sends the information to the computer. Alternatively, if only serial connections are available from a power meter, a serial protocol such as DNP3 or Modbus can be employed.

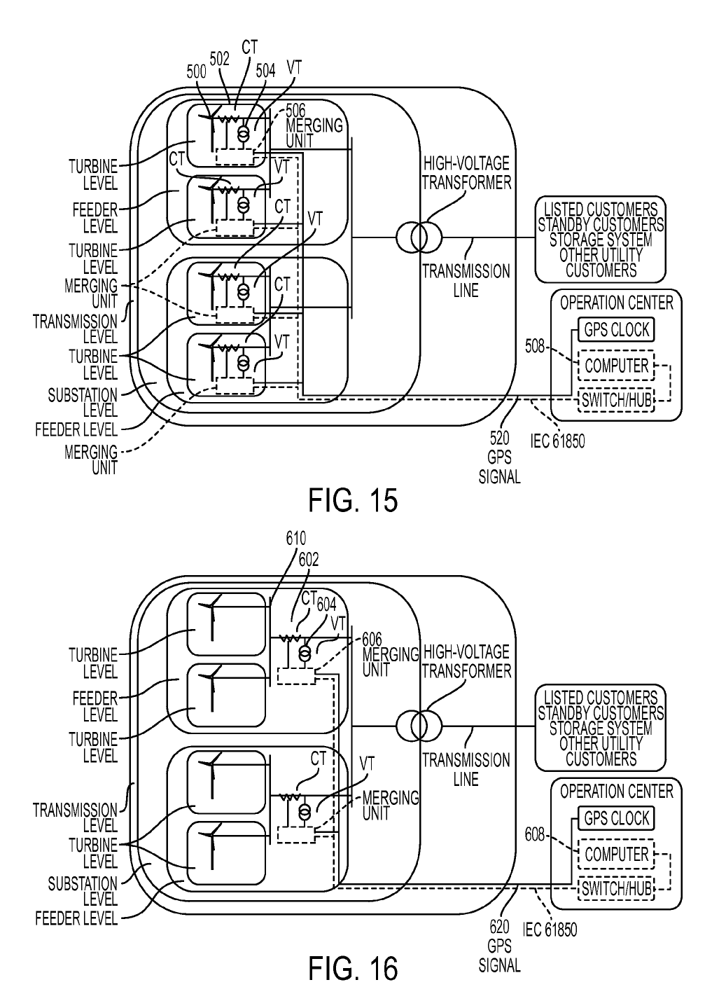

The data acquisition system is depicted in FIGS. 15-18. Generation data can be acquired at any one of a variety of levels, including the level of the generation unit (e.g. wind turbine), the level of the feeder, the level of the substation, or the level of the transmission system. These variants are shown in FIGS. 15-18, respectively.

In FIG. 15, data is collected at the level of the generation unit (e.g. wind turbine, 500). A power meter or, alternatively, a merging unit (506) collects signals from a current transformer (502) and a voltage transformer (504), and sends a signal to the VGen-RTI processor (508) with information about the unit's instantaneous power generation.

In FIG. 16, data is collected at the level of the feeder (in this example shown as connecting two wind turbines, 610). A power meter or, alternatively, a merging unit (606) collects signals from a current transducer (602) and a voltage transducer (604) and sends a signal to the VGen-RTI processor (608) with information about the total instantaneous power generation from the units in the feeder.

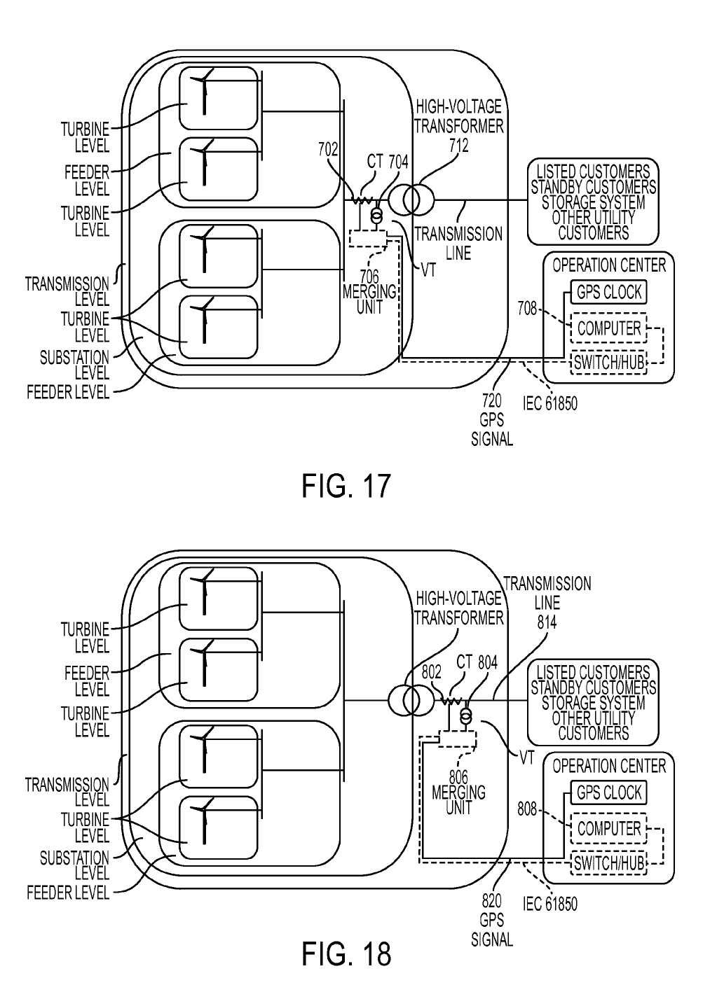

In FIG. 17, data is collected at the level of the substation (712). A power meter or, alternatively, a merging unit (706) collects signals from a current transducer (702) and a voltage transducer (704) and sends a signal to the VGen-RTI processor (708) with information about the total instantaneous power generation from the units in the power plant.

In FIG. 18, data is collected at the level of the transmission (814). A power meter or, alternatively, a merging unit (806) collects signals from a current transducer (802) and a voltage transducer (804) and sends a signal to the VGen-RTI processor (808) with information about the total instantaneous power generation from the units in the power plant.

In some embodiments, all data is time-synchronized either by a GPS clock signal (520 in FIG. 15, 620 in FIG. 16, 720 in FIGS. 17, and 820 in FIG. 18) or via communication channels using a standard time synchronization protocol such as WEE 1588. The time signal is used predominantly to perform any needed corrections to the phase of the generation signal.

The choice of the level at which data acquisition is implemented depends on a variety of factors. For example, when merging units are needed, data acquisition at the level of the generation unit will likely involve higher capital investments, since merging units would he required for each unit. On the other extreme, data acquisition at the level of the transmission system may be more economical, but it may need special agreements with the electric utilities, which typically own the transmission infrastructure.

### Balancing Functionality

VGen-RTI delivers a balancing functionality by continuously matching charge to customer loads and generation surplus. How the balancing functionality is implemented may depend on the type of markets involved. When the market is composed only of standby loads, VGen-RTI needs to ensure that the total online load (total maximum input power) is equal or bigger than the instantaneous generation surplus. When the market includes also listed loads, VGen-RTI also ensures that sufficient generation surplus will be available in order to supply these loads with the amount of energy they need by a given time.

In all cases, VGen-RTI uses robust short-term forecasts of generation surplus, enabled by the direct access high-frequency data sampled from RTC generation signals.

VGen-RTI uses information on power generation and power demand during a given period of time (e.g. one hour) to determine a suitable reference generation for the same period. Alternatively, when restrictions exist on the reference generation (for example, when that level is fixed by the system operator), VGen-RTI uses this information and information on power generation to define the demand for the period (for example, it accepts or rejects agreements with prospective listed customers).

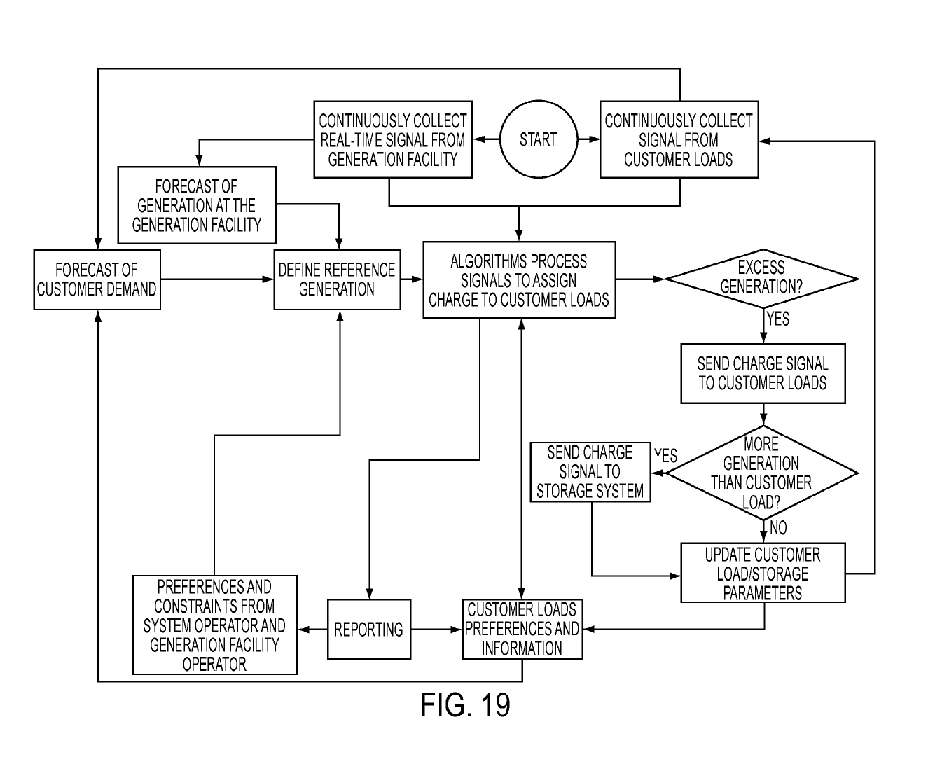

FIG. 19 shows a flow chart describing the steps involved in one embodiment of our PCEM solution. For a clearer exposition, there is a starting point, although it should be understood that once the system is started is operates continuously and then the notion of a starting point is less meaningful. The first two blocks describe the acquisition of real time information about power generation and online customer loads. The charge assignment algorithm takes these pieces of information as well as information reference generation and customer preferences to propose a charge assignment to the online customer loads. If there is generation in excess of the reference generation that can be distributed, charge assignments are transformed into charge signals and sent to the customer loads. Even though our PCEM system attempts to match excess generation with available dispatchable customer load, there may still be instances when the former is higher than the latter. In such instances, charge signals are sent also to the energy storage system. The energy stored in the energy storage system would be redirected to customers whenever desired, particularly when there is not sufficient excess generation to distribute (this process is not specifically indicated in the flow chart). Every time that charge signals are sent to customer loads, the values of various parameters are updated, particularly for the purpose of informing customers. Forecasts of power generation and customer arrival and demand would in general be useful to inform the charge assignment from our algorithms, as illustrated in this embodiment of our PCEM solution.

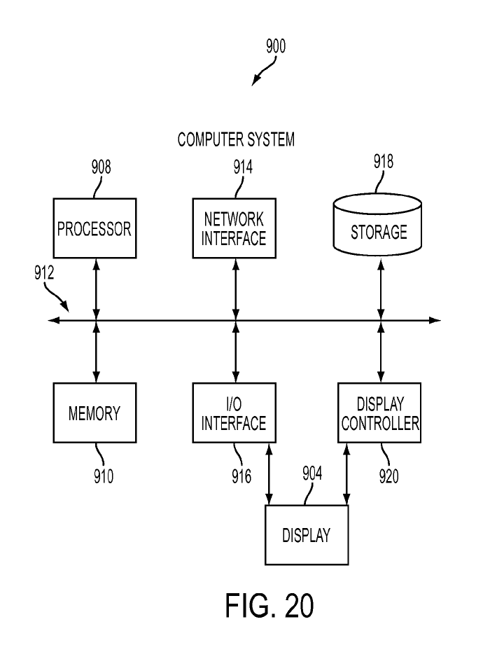

FIG. 20 illustrate one exemplary embodiment of a computer system (900) in which the systems and methods disclosed herein can be implemented or which can be used in connection with the systems and methods disclosed herein. The computer system (900) can include any of a variety of software and/or hardware components, and it will be appreciated that functions disclosed herein as being performed by a computer system can be implemented in software, hardware, or a combination thereof. In addition, although an exemplary computer system (900) is depicted and described herein, it will be appreciated that this is for sake of generality and convenience. In other embodiments, the computer system may differ in architecture and operation from that shown and described here.

The illustrated computer system (900) includes a processor (908) which controls the operation of the computer system (900), for example by executing an operating system (OS), a basic input/output system (BIOS), device drivers, application programs, and so forth. The processor (908) can include any type of microprocessor or central processing unit (CPU), including programmable general-purpose or special-purpose microprocessors and/or any one of a variety of proprietary or commercially-available single or multi-processor systems. The computer system (900) also includes a memory (910), which provides temporary storage for code to be executed by the processor (908) or for data that is processed by the processor (908). The memory (910) can include read-only memory (ROM), flash memory, one or more varieties of random access memory (RAM), and/or a combination of memory technologies. The various elements of the computer system (900) are coupled to a bus system (912). The illustrated bus system (912) is an abstraction that represents any one or more separate physical busses, communication lines/interfaces, and/or multi-drop or point-to-point connections, connected by appropriate bridges, adapters, and/or controllers.

The computer system (900) also includes a network interface (914, an input/output (IO) interface (916), a storage device (918), and a display controller (920). The network interface (914) enables the computer system (900) to communicate with remote devices (e.g., other computer systems, power generation devices or facilities, customer loads, and storage systems) over a network. The IO interface (916) facilitates communication between one or more input devices (e.g., touch screens, keyboards, or pointing devices), one or more output devices (e.g., speakers, printers, or removable memories), and the various other components of the computer system (900). The storage device (918) can include any conventional medium for storing data in a non-volatile and/or non-transient manner. The storage device (918) can thus hold data and/or instructions in a persistent state (i.e., the value is retained despite interruption of power to the computer system (900). The storage device (918) can include one or more hard disk drives, flash drives, USB drives, optical drives, various media disks or cards, and/or any combination thereof and can be directly connected to the other components of the computer system (900) or remotely connected thereto, such as over a network. The display controller (920) can, for example, includes a video processor and a video memory, and generates images to be displayed on one or more displays in accordance with instructions received from the processor (908).

The computer system (900) includes a display (904) that is optionally capable of receiving input from a user (i.e., a touch screen display). The display (904) is coupled to the display controller (920, which provides images to be displayed on the display (904). The display (904) is also optionally coupled to the IO interface (916), such as in embodiments when the display is a touch display. Software executed by the processor (908) can recognize or interpret inputs.

One or more software modules can be executed by the computer system (900) to facilitate the calculations and determinations as described herein with the computer system (900). These software modules can be part of a single program or one or more separate programs, and can be implemented in a variety of contexts (e.g., as part of an operating system, a device driver, a standalone application, and/or combinations thereof). It will be appreciated that functions disclosed herein as being performed by a particular module can also be performed by any other module or combination of modules.

While the above description provides examples and specific details of various embodiments, it will be appreciated that some features and/or functions of the described embodiments admit to modification without departing from the scope of the described embodiments. The above description is intended to be illustrative of the invention, the scope of which is limited only by the language of the claims appended hereto.

The section headings used herein are for organizational purposes only and are not to be construed as limiting the subject matter described in any way.

### Examples

In one example, a model method modeling customer behavior is provided. Standby users are assumed to arrive following a learning stochastic process, with inter-arrival times that are generally independent of other inter-arrival times. Such process can be modeled for the purposes of simulation, for example, as a Poisson process. There is no a-priori reason to believe that the rate parameter for the Poisson process should be constant, thus arrivals are more generally modeled as a non-homogenous Poisson process, so that the expected number of arrivals per unit of time could be expressed as

$$f ( k , λ ) = \frac{{λ}_{t 1 , t 2}^{k} {e}^{- {λ}_{t 1 , t 2}}}{k !} ,$$

where λ_{c1,c2}=∫_{c1}^{c2}λ(t)dt.

Listed users are scheduled in advance in accordance with the forecasted availability of generation surplus. Thus, listed load demand is known to VGen-RTI.

For each listed load k, VGen-RTI determines the maximum input power (pₖₘₐₓⁱ), the amount of energy needed (eₖ⁺), the latest time by which the delivery of this amount of energy needs to be completed (tₖ⁻), and the earliest time when energy delivery can start (tₖⁱ).

The amount of energy delivered to the load during the hour starting at t₀ is

eₖ∫ₜ_{₀}^{c}pₖ(τ)dτ,

where pₖⁱ is the instantaneous power delivered to load k and 0≦pₖₘₐₓⁱ. pₖⁱ can be a continuous or a stepwise function, depending on the values it can take within the interval. In the simplest case,

$${p}_{k}^{i} = \{ \begin{matrix}0 \\ {p}_{kmax}^{i}\end{matrix} ,$$

representing the “switch off” and “switch on” states.

Unless all the requested energy, eₖ⁺, is delivered before the deadline, tₖ⁻, there will be a time, tₖ⁺, at which the max power will need to start being applied continuously, so that the energy requirement is met by the deadline. The value of this time will depend on the amount of energy delivered since the start of the charging. Initially, its value is

$${t}_{k}^{i *} = {t}_{k}^{*} - \frac{{e}_{k}^{*}}{{p}_{kmax}^{i}} .$$

This time can be estimated as

ēₖ=eₖ⁻eₖ=eₖ⁺−∫ₜ_{₀}^{c}pₖ(τ)dτ.

Supplying all the rest of the energy at maximum input power could be done in the interval

t_{f}−t₀=ēₖ/pₖₘₐₓⁱ.

Taking t_{f}≡tₖ⁺, t₀≡tₖⁱ⁺. Replacing above, we obtain (tₖ⁺−tₖⁱ⁺)pₖₘₐₓⁱ=ēₖ. Inserting this above, and solving for tₖⁱ⁺, we obtain

$${t}_{k}^{i *} = {t}_{k}^{*} - \frac{1}{{p}_{kmax}^{i}} ( {e}_{k}^{*} - {\int }_{{t}_{0}}^{t} {p}_{k} ( τ ) d τ ) .$$

This is the generic expression for the time after which continuous maximal power has to be supplied to the load in order to meet its energy requirements on time.

For times in the interval [tₖⁱ,tₖⁱ⁺), power can be supplied to load k according to our scheduling rules, as defined by the availability of generation surplus and the priorities of loads in the queue. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

1. A method of power control and energy management comprising:
obtaining real time data from one or more variable power generation facilities at a sampling frequency of at least one sample per minute;
obtaining real time data from one or more customer loads at a sampling frequency of at least one sample per minute;
optionally exchanging information with the system operator;
defining a reference generation;
calculating a charge assignment based on said data from one or more variable power generation facilities, said data from one or more customer loads, said information from the system operator, and said reference generation;
determining charge signals based on said charge assignment; and
sending said charge signals to customer loads and/or to a storage system at a rate of more than one per minute.

2. The method of claim 1, wherein said method further provides a balancing functionality whereby instantaneous generation surplus is completely allocated to customer loads.

3. The method of claim 1 or claim 2, wherein said method further provides a user-control functionality that allows the user to control charge and/or monitor the energy received.

4. The method of any of the preceding claims, wherein two or more distinct customer types are distinguished and in said calculating charge assignment.

5. The method of any of the preceding claims, wherein said sampling frequency for obtaining data from one or more variable power generation facilities and said sampling frequency for obtaining data from one or more customer loads, and said rate for sending a charging signal are each more than ten samples per minute.

6. The method of claim 5, wherein said sampling frequency for obtaining data from one or more variable power generation facilities and said sampling frequency for obtaining data from one or more customer loads, and said rate for sending a charging signal are each more than one sample per second.

7. The method of any of the preceding claims, further comprising providing one or more ancillary services.

8. The method of claim 7, wherein said ancillary service is load balancing.

9. The method of any of the preceding claims, wherein said one or more variable power generation facilities is a wind energy farm.

10. The method of any of the preceding claims, wherein said data from one or more variable power generation facilities includes both total power and change in power.

11. The method of any of the preceding claims, wherein said remote charging signal has a variable power level.

12. The method of any of the preceding claims, wherein said step of dynamically calculating charge assignment comprises using a charge assignment algorithm to assign specific amounts of charge to each online customer load.

13. The method of any of the preceding claims, wherein said method is performed independent of the Independent System Operator (ISO) participation.

14. The method of any of claims 1-12, further comprising obtaining congestion information from an Independent System Operator (ISO).

15. A computer-assisted method of integrating wind energy/electrical energy load shifting comprising the steps of:
obtaining real time data from one or more variable power generation facilities at a sampling frequency of at least one sample per minute;
obtaining real time data from one or more customer loads at a sampling frequency of at least one sample per minute;
optionally exchanging information with the system operator;
defining a reference generation;
calculating a charge assignment based on said data from one or more variable power generation facilities, said data from one or more customer loads, said information from the system operator, and said reference generation;
determining charge signals based on said charge assignment; and
sending said charge signals to customer loads and/or to a storage system at a rate of more than one per minute.

16. A computer readable device having instructions stored therein for causing a computer to implement a method, the method comprising:
obtaining real time data from one or more variable power generation facilities at a sampling frequency of at least one sample per minute;
obtaining real time data from one or more customer loads at a sampling frequency of at least one sample per minute;
optionally exchanging information with the system operator;
defining a reference generation;
calculating a charge assignment based on said data from one or more variable power generation facilities, said data from one or more customer loads, said information from the system operator, and said reference generation;
determining charge signals based on said charge assignment; and
sending said charge signals to customer loads and/or to a storage system at a rate of more than one per minute.
